(19) United States
(12) Patent Application Publication
(10) Pub. No.: US 2006/0120827 A1
(43) Pub. Date: Jun. 8, 2006

(54) Method and device for production of a brochure

(76) Inventor: Dieter Gansert, Kindenheim (DE)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(21) Appl. No.: 10/542,212

(22) PCT Filed: Jan. 14, 2004
(86) PCT No.: PCT/DE04/00027

§ 371 Date: Jul. 14, 2005

(30) Foreign Application Priority Data
Jan. 14, 2003 (DE) 103-00-986.8

(51) Int. Cl. B42C 9/00

(52) U.S. Cl. 412/1

(57) ABSTRACT

A method and a device are provided for production of a brochure. At least one contents sheet and a cover sheet are arranged one above the other, joined and folded in a folding device. The method and the device shorten the production time for the brochure. This is accomplished in that the contents sheet and the cover sheet are placed in separate guide planes before folding, these guide planes lying one above the other at a distance from one another in the vicinity of a folding device, in that a stripe of glue is applied by a joining supply device for joining the sheets before folding, and in that the folding device is moved in such a way that the sheets are joined and folded simultaneously, where the folding device operates at the same time as a joining device.

### CROSS REFERENCE TO RELATED APPLICATIONS

This application claims priority of International Application No. PCT/DE2004/000027, filed Jan. 14, 2004, and German Application No. 103 00 986.8, filed Jan. 14, 2003, the complete disclosures of which are hereby incorporated by reference.

### BACKGROUND OF THE INVENTION

a) Field of the Invention

The present invention is directed to a method for the production of a brochure, wherein at least one contents sheet and one cover sheet are arranged one above the other, joined to one another, and folded. Further, a device is indicated for the production of a brochure with at least one sheet feed, with a joining device for joining a cover sheet to at least one contents sheet, and with a folding device.

b) Description of the Related Art

A brochure is a bookbinding product in the form of a booklet having a paper cover or a cardboard cover. All sheets—the contents sheets and cover sheet—are joined together at the back of the brochure, in particular by means of stapling or by gluing.

Two basic methods along with corresponding devices for the production of a brochure are known from practice.

When assembling, a plurality of unfolded sheets are mechanically or manually gathered in a stack on a belt and are then joined at the back. Finally, the joined stack is folded by a folding blade acting in the area of the back. This is followed by a cutting process. This method has the advantage of low mechanical costs, but the folding quality achieved is inferior because the brochure can always open up again by itself depending upon the paper used and its material stiffness and elasticity. In addition, it takes time to form the stack.

When stapling together, the pre-folded sheets are placed one on top of the other in the desired quantity and fed to a stapling machine, where the back is stapled and a cutting process takes place subsequently. The sheets are stacked manually or mechanically on a collecting chain leading to the stapling machine. Since the sheets are pre-folded, the back edge is sharp and the quality of the brochure is high. Stapling together is disadvantageous due to the high cost of machinery and preparation involved in pre-folding. Further, feeding the sheets to the collecting chain is very expensive in terms of time and labor.

There is a high demand for low-volume brochures above all in the pharmaceutical industry because folded inserts in pharmaceutics packaging are difficult to handle, especially when placing them back into the packaging.

DD 57590 discloses a device for the production of writing tablets. A printing machine, a rotary stack feeder, a tacking device and a folding device are combined. In this case, stacks of contents sheets are joined to a cover sheet. The sheets lying on top of one another are aligned, tacked at a tacking station and then folded while already in the joined state. In this device, a method step is required for collecting and assembling. The joining of the sheets takes place in a separate station. A very extensive production line is required and long distances must be traversed. The individual—spatially separated—method steps result in long production times.

WO 98/14333 discloses a method and a device for fastening one or more pages in a cover. The cover sheet is supplied, a crease is made and a stripe of glue is applied in the area of the fold. A contents sheet, or a plurality of contents sheets, is fed at right angles to the feed direction of the cover sheet and arrive in the cover sheet. The contents sheets are fed in such a way that they press the cover sheet in the area of the stripe of glue through a guide slot and folding takes place. The contents sheets are perpendicular to the cover sheet and take over the folding function. However, only the cover sheet is folded.

### OBJECT AND SUMMARY OF THE INVENTION

Proceeding from the prior art known from DD 57590, the invention has the primary object of providing a method and a device of the type mentioned in the beginning which shortens production time.

The above-stated object is met with respect to the method by a method in accordance with the invention which is so designed that the contents sheet and the cover sheet are placed on separate guide planes before folding, these guide planes lying one above the other at a distance from one another in the vicinity of a folding device, in that a stripe of glue is applied for joining the sheets before folding, and in that the folding device is moved in such a way that the sheets are joined together and folded simultaneously. The above-stated object is met with respect to a device in accordance with the invention which is so constructed that two guide planes lying one above the other at a distance from one another are provided in the vicinity of the folding device for separate placement of the contents sheet and cover sheet in a guide plane, respectively, in that a joining means supply device is provided for applying joining means, in particular a stripe of glue, and in that the folding device simultaneously joins the sheets when folding.

Taking DD 57590 as the generic starting point, the invention recognized first that gathering sheets, placing these sheets one on top of the other, aligning and then joining these sheets on a cumbersome production line prior to the folding process is very time-consuming. Further, it was recognized that the production time can be shortened when the contents sheet and cover sheet are placed in separate guide planes which lie one above the other at a distance from one another in the vicinity of the folding device. In this way, the final product is prepared in situ in a way, namely, in the folding device, without having to lay the sheets themselves on top of one another. Further, there is also offered the possibility of guiding the sheets to the guide plane from a folding machine or a feeder directly—that is, not along extended paths on a production line in successive time-consuming method steps. Finally, it was recognized that the production time can also be shortened in that the joining device is not arranged outside of the area of the folding device as in the prior art, but rather the folding device is moved in such a way that the sheets are joined together and folded simultaneously, and a stripe of glue is applied prior to folding in order to join the sheets before folding. Accordingly, the folding device is combined, according to the invention, in cooperation with the stripe of glue to form the joining device.

In conformity with the usual descending direction of a folding blade, the cover sheet could be placed on the lower guide plane and the contents sheet could be placed on the upper guide plane. This embodiment form is simple to realize with respect to design; however, for certain applications the folding blade could also work in an other direction. The guide plane facing the folding blade receives the contents sheet and the guide plane that is farther away from the folding blade receives the cover sheet. For example, a folding blade that is guided upward from below is possible, or structural factors require the vertical orientation of the guide planes with a folding blade that is guided perpendicular to the guide planes.

The contents sheet could be a single sheet that is directly fed into the guide plane by a feeder. For multi-sided brochures, the contents sheet is a sheet that is folded n times and likewise arrives in the guide plane directly from a folding machine. Feeding a folded sheet into the folding device or to the guide planes ultimately results in a brochure having the high quality of a tacked product, but at a lower cost in machinery and labor, as the case may be, and in a shorter time. The cover sheet is generally a single sheet, although possible deviations are not excluded. With respect to the feed of the cover sheet, it is also essential for the idea of shortening production time that this is carried out directly from a feeder to the guide plane. The feed of the sheets is carried out successively, specifically when the folding process is concluded and the guide planes are free again and the folded product is removed. In accordance with the above-mentioned convention descending direction toward the ground, the feeder for the cover sheet could be arranged at the lower guide plane and the folding machine or the feeder for the contents sheet could be arranged at the upper guide plane.

It is particularly advantageous that the cover sheet and the contents sheet are fed to the two guide planes at the same time from opposite directions. For this purpose, the feeder for the cover sheet and the folding machine or feeder for the contents sheet could be arranged on opposite sides of the guide planes so that the cover sheet and the contents sheet can be transported in opposite directions simultaneously. On one hand, this results in an optimal cycle time because the cover sheet and contents sheet achieve the predetermined position relative to one another simultaneously and the folding device can be actuated directly to form, and finally remove, the brochure so that space is available again for the next sheet. On the other hand, feeding from opposite directions is advantageous in that the folding machine or the feeder for supplying the contents sheet and the feeder for supplying the cover sheet can be advanced directly to the two guide planes as mobile devices and will not interfere with one another due to the different feed directions. It would also be conceivable to supply the sheets in the same direction. In this case, the feeders or the feeder and the folding machine would be arranged on the same side of the two guide planes. Alternatively or in addition to the feeders and the folding machine, as feed means, the two guide planes which are to be arranged in the vicinity of the folding device, the folding device and the joining device could also be constructed as mobile devices and advanced directly to the folding machine or feeder for the contents sheet and to the feeder for the cover sheet which can also be mobile or stationary. In this way, a high degree of flexibility is achieved in the production sequences.

Joining means, particularly in the form of a stripe of glue, could be applied before feeding the cover sheet to the lower guide plane so that all of the sheets—folded contents sheet and cover sheet, as the case may be—can be joined at the back of the brochure. By means of this preparatory method step, the sheets that are placed one on top of the other are then joined or glued simultaneously during folding. Sheets were formerly joined prior to folding, which could result in misalignment of the sheets and increased after-working expenditure. In theory, the cover sheet and the contents sheet could also be joined by a thread seal or by tacking in the method according to the invention when they are placed on the two guide planes in an exact fit.

In the method according to the invention and when using the device according to the invention, the contents sheet and the cover sheet could be fed to the two guide planes on the order of a maximum of approximately 15,000 to 20,000 sheets per hour. Many different speeds and quantities can be realized depending on the construction of the feeder, the folding machine, the respective feed device and the folding device.

Monitoring is advisably carried out in the vicinity of the folding device to determine whether or not the contents sheet and cover sheet are ready and exactly positioned on the guide planes. Monitoring can also be oriented to the quality of the sheet. In order to prevent paper jams and in order that space is always immediately available on the guide planes for the supply of subsequent sheets, defective or incorrectly positioned contents sheets and cover sheets are sorted out of the folding device and removed.

Stops could be provided at the guide planes for exact positioning of the sheets. The monitoring devices could be photocells. In order to sort out and remove defective or incorrectly positioned contents sheets and cover sheets from the folding device, a sorting device, e.g., in the form of a switch, could be provided.

In the most common application of the invention, a cover sheet and a contents sheet that is folded multiple times are folded to form a brochure. In theory, a plurality of sheets could also be supplied, in which case steps must then be undertaken to maintain accurate fit and accurate positioning.

After the folding process, the brochure is guided away, particularly via rollers, and its quality features could then be detected. For this purpose, a good/bad detection device could be provided for detecting the brochure after it exits the folding device or for quality features. In order to page the contents sheet which is folded n-times, where n is greater than or equal to 1, the brochure is fed to a trimming or cutting machine after folding and is cut therein. Quality monitoring processes are also advisable in connection with the trimming or cutting machine.

It is noted with respect to the device that the position of stops of the two guide planes can be varied and the stops can therefore be adjusted to different sheet formats.

There are various advantageous possibilities for the embodiment and further development of the teaching of the present invention. In this respect, reference is had to the subclaims following claims 1 and 16 and to the following description of an embodiment example of the invention with reference to the drawings. In connection with the description of the embodiment example of the invention, preferred constructions and further developments of the teaching are also described in general.

### BRIEF DESCRIPTION OF THE DRAWINGS

In the drawings:

FIG. 1 is a purely schematic front view of the device according to the invention; and

FIG. 2 is a purely schematic side view of the device according to the invention.

### DESCRIPTION OF THE PREFERRED EMBODIMENTS

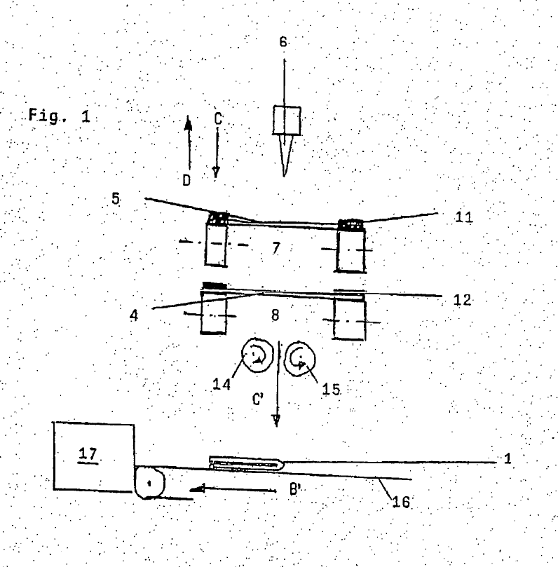

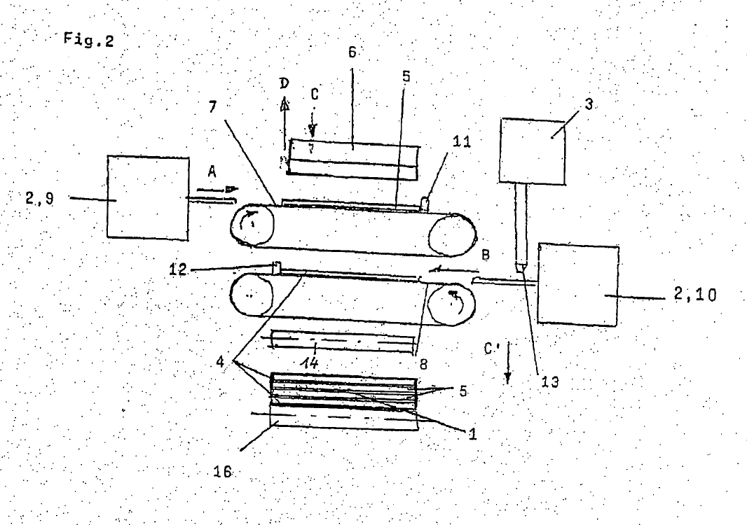

FIGS. 1 and 2 show a device for the production of a brochure 1 having two sheet feeds 2 which feed a cover sheet 4 and a contents sheet 4 in the vicinity of a folding device 6.

According to the invention, two guide planes 7, 8 which are arranged one above the other at a distance from one another for separate placement of the contents sheet 5 and the cover sheet 4 in a respective guide plane 7, 8 are provided in the vicinity of the folding device 6. Further, a joining means supply device 3 with a glue dispensing device 13 applies a stripe of glue to the cover sheet 4. The folding device 6 joins the sheets 4, 5 simultaneously during folding and, in cooperation with the stripe of glue, is therefore a folding device and a joining device at the same time.

The guide planes 7, 8 are realized by means of two conveyor belts that are spaced apart and on which the sides of the sheets 4, 5 lie so that the central surface of the sheets 4, 5, where folding is also carried out, remains free.

The upper guide plane 7 for the contents sheet 5 cooperates with a folding machine 9 and is supplied with a contents sheet 5 by the latter in immediate succession. The lower guide plane 8 for the cover sheet 4 cooperates with a feeder 10 and is supplied with a cover sheet 4 by the latter in immediate succession. The feeder 10 for the cover sheet 4 and the folding machine 9 for the contents sheet 5 are arranged on opposite sides of the guide planes 7, 8 so that the cover sheet 4 and the contents sheet 5 are transported simultaneously in opposite directions A, B. The conveyor belts of the two guide planes 7, 8 have opposite conveying directions A, B. Approximately 15,000 to 20,000 contents sheets 5 and cover sheets 4 are guided per hour to the two guide planes 7, 8 up to their stops 11, 12.

In the present embodiment example, the device does not occupy much space because the folding machine 9 for the contents sheet 5 and the feeder 10 for the cover sheet 4 are mobile devices which are advanced directly to the two guide planes 7, 8.

Before the cover sheet 4 is deposited in the guide plane 8, it is provided with glue from the joining means supply device 3. The glue is applied by a glue dispensing device 13 to the cover sheet 4, where the folded and glued back of the brochure 1 is to be formed.

The contents sheet 5 and the cover sheet 4 that has been prepared with glue are conveyed up to the stops 11, 12 of the respective guide planes 7, 8. Monitoring devices, not shown, detect whether or not the contents sheet 5 and cover sheet 4 are exactly positioned on the guide planes 7, 8 and cause a sorting device, not shown, to sort out defective or incorrectly positioned contents sheets 5 and cover sheets 4 from the vicinity of the folding device 6 and remove them. As soon as errors are eliminated, the folding and joining process takes place in that the folding device 6 is moved in direction C so that the sheets 4, 5 are glued together and folded simultaneously. Two rollers 14 and 15 grip the brochure 1 and transport it in direction C to a transport belt 16. At the same time, the folding device 6 moves again in direction D into the starting position; new sheets 4, 5 are supplied as soon as the guide planes 7, 8 are free.

A good/bad detection device, not shown, which detects quality features of the brochure 1 is provided in the area between the rollers 14, 15 and the transport belt 16. In the present embodiment example, the contents sheet 5 is a sheet that is folded three times. In a freely selected conveying direction B′, the good-quality brochure 1 is now transported to a cutting device 17, indicated schematically in FIG. 2, where it is put into a paginated state.

For further features not shown in the drawing, reference is had to the general part of the description.

While the foregoing description and drawings represent the present invention, it will be obvious to those skilled in the art that various changes may be made therein without departing from the true spirit and scope of the present invention.

### REFERENCE NUMBERS

1 brochure
2 sheet feed
3 joining means supply device
4 cover sheet
5 contents sheet
6 folding device
7 guide plane
8 guide plane
9 folding machine
10 feeder
11 stop of 7
12 stop of 8
13 glue dispensing device
14 roller
15 roller
16 transport belt
17 cutting device
A transporting direction for 5
B transporting direction for 4
B∝ transporting direction for 1
C movement direction of 6 for carrying out folding
C′ output direction of 1 from 14, 15
D movement direction of 6 to starting position

1-25. (canceled)

26. A method for production of a brochure comprising the steps of:
joining at least one contents sheet and a cover sheet to one another and folding said sheets;
applying a stripe of glue for joining the sheets before folding; and
further comprising the steps of placing the contents sheet and cover sheet in separate guide planes before folding, said guide planes lying one above the other at a distance from one another in the vicinity of a folding device; and
moving the folding device in such a way that the sheets are joined to one another and folded simultaneously.

27. The method according to claim 26, wherein the cover sheet is placed on the lower guide plane and the contents sheet is placed on the upper guide plane.

28. The method according to claim 26, wherein the contents sheet reaches the guide plane directly from a feeder.

29. The method according to claim 26, wherein the contents sheet which is folded n times reaches the guide plane directly from a folding machine.

30. The method according to claim 26, wherein the cover sheet reaches the guide plane directly from a feeder.

31. The method according to claim 26, wherein the two guide planes are supplied from opposite directions simultaneously with the cover sheet on one side and the contents sheet on the other side.

32. The method according to claim 26, wherein the folding machine or the feeder for the contents sheet and the feeder for the cover sheet are mobile devices that are advanced directly to the two guide planes.

33. The method according to claim 26, wherein the two guide planes, the folding device and the joining means supply device are mobile devices that are advanced directly to the folding machine or feeder for the contents sheet and to the feeder for the cover sheet.

34. The method according to claim 26, wherein the cover sheet is provided with joining means, particularly a stripe of glue, before it is placed in the guide plane.

35. The method according to claim 26, wherein a maximum of 15,000 to 20,000 contents sheets and cover sheets per hour are fed to the two guide planes.

36. The method according to claim 26, wherein the area of the folding device is monitored to determine whether or not the contents sheet and cover sheet are already placed and/or exactly positioned on the guide planes and/or have deficient quality.

37. The method according to claim 26, wherein defective and/or incorrectly positioned contents sheets and cover sheets are sorted out of the folding device and removed.

38. The method according to claim 26, wherein a cover sheet and a contents sheet are folded to form the brochure.

39. The method according to claim 26, wherein the quality features of the brochure are detected after folding.

40. The method according to claim 26, wherein the brochure is fed to a trimming or cutting device after folding and is cut therein.

41. A device for carrying out the method according to claim 26, comprising:
at least one sheet feed;
a joining means supply device for applying joining means;
a joining device for joining a cover sheet to at least one contents sheet; and
a folding device;
two guide planes lying one above the other at a distance from one another being provided in the vicinity of the folding device for separate placement of the contents sheet and cover sheet in a guide plane, respectively; and
said folding device being simultaneously a joining device so that the sheets can be joined during folding.

42. The device according to claim 41, wherein the guide plane for the contents sheet cooperates with a folding machine or with a feeder and can be supplied by the latter with a contents sheet in immediate succession.

43. The device according to claim 41, wherein the guide plane for the cover sheet cooperates with a feeder and can be supplied with a cover sheet by the latter in immediate succession.

44. The device according to claim 41, wherein the folding machine or the feeder for the contents sheet is arranged at the guide plane adjacent to the folding device, in particular at the upper guide plane.

45. The device according to claim 41, wherein the feeder for the cover sheet is arranged at the guide plane adjacent to guide plane, in particular at the lower guide plane.

46. The device according to claim 41, wherein the feeder for the cover sheet and the folding machine or feeder for the contents sheet are arranged on opposite sides of the guide planes so that the cover sheet and the contents sheet can be transported in opposite directions simultaneously.

47. The device according to claim 41, wherein stops are provided at the guide planes and, in particular, can be adjusted to the dimensions of the sheets.

48. The device according to claim 41, wherein monitoring devices which detect whether or not the contents sheet and cover sheet are placed and/or exactly positioned on the guide planes and/or which detect deficient quality are provided in the vicinity of the folding device.

49. The device according to claim 41, wherein a sorting device is provided which sorts out defective or incorrectly positioned contents sheets and cover sheets from the vicinity of the folding device and removes them.

50. The device according to claim 41, wherein a good/bad detection device is provided which detects quality features of the brochure after it exits the folding device.
